(19) United States
(12) Patent Application Publication
(10) Pub. No.: US 2018/0169573 A1
(43) Pub. Date: Jun. 21, 2018

(54) PROCESS FOR TREATING A GAS CONTAMINATED BY METALS OR ORGANICS COMPOUNDS USING A CALCIUM-PHOSPHATE REACTANT COMPRISING APATITE

(71) Applicant: SOLVAY SA, Brussels (BE)

(72) Inventors: Thierry DELPLANCHE, Mont-St-Guibert (BE); Olivier BODSON, Duisburg (BE); Dirk BREUGELMANS, Vilvoorde (BE); Patrick PERRIN, Dombasle-sur-Meurthe (FR); Jean-Pascal BALLAND, Düsseldorf (DE)

(21) Appl. No.: 15/578,865

(22) PCT Filed: Jun. 3, 2016
(86) PCT No.: PCT/EP2016/062653

§ 371 Date: Dec. 1, 2017

Related U.S. Application Data
(60) Provisional application No. 62/170,680, filed on Jun. 3, 2015.

(51) Int. Cl. B01D 53/34; B01J 20/04; B01D 53/44; B01D 53/64; B01D 53/80; B01D 53/46; B01D 53/83; B01D 39/06; B01D 53/72; B01D 53/75

(52) U.S. Cl. CPC B01D 53/346; B01D 2239/0208; B01J 20/043; B01J 20/041; B01D 53/44; B01D 53/64; B01D 53/80; B01D 53/46; B01D 53/83; B01D 39/06; B01D 53/72; B01D 53/75; B01D 2251/404; B01D 2251/512; B01D 2251/606; B01D 2251/60; B01D 2251/304; B01D 2253/102; B01D 2257/2045; B01D 2257/2047; B01D 2257/302; B01D 2257/60; B01D 2257/602; B01D 2257/7027; B01D 2257/708; B01D 2258/0283; B01D 2258/0291; B01J 20/048

(57) ABSTRACT

Process for treating a gas contaminated by at least one element selected from the group consisting of heavy metals, organic compounds, and combinations thereof, wherein a calcium-phosphate reactant (reagent) particle comprising apatite is brought into contact with the contaminated gas at a temperature of at least 30° C. and preferably at most 1100° C. The metal(s) and/or organic compound(s) to be removed from the contaminated gas may be selected among the list of: Al, Ag, As, Ba, Be, Bi, Ce, Co, Cd, Cu, Cr, Fe, Hf, Hg, La, Li, Mg, Mn, Mo, Ni, Pb, Pd, Rb, Sb, Se, Sn, Sr, Th, Ti, U, V, Y, Zn, Zr, VOC, aromatic compounds, PAHs, dioxins, furans, or any mixture thereof. In such process, an alkaline compound particle comprising sodium bicarbonate, sodium carbonate, sodium sesquicarbonate (trona), quick lime, hydrated lime, lime stone or combinations thereof, may be further brought into contact with the contaminated gas.

### CROSS-REFERENCE TO RELATED APPLICATIONS

This application claims priority to U.S. provisional application No. 62/170,680 filed on Jun. 3, 2015, the whole content of this application being incorporated herein by reference for all purposes.

### TECHNICAL FIELD

The invention relates to a process for treating gas contaminated by heavy metals or organic compounds using a calcium-phosphate reactant comprising apatite.

### BACKGROUND

The problems posed by the impact of volatile metals, and in particular of heavy metals in the environment are well known. Numerous industrial processes release liquid or gaseous effluents that are heavily loaded with heavy metals, in particular heavy metal soluble salts, such as cationic or anionic form salts. The expression “heavy metals” is understood to mean metals whose density is at least equal to 5 g/cm³, and also beryllium, arsenic, selenium, and antimony, in accordance with the generally accepted definition (Heavy Metals in Wastewater and Sludge Treatment Processes; Vol I, CRC Press Inc; 1987; page 2). Lead, cadmium, or chromium are particularly significant examples, given their harmful effect on the human body. Nickel is another example thereof due to its allergenic effect.

Organics pollutant such as: volatile organic compounds (VOC), aromatic compounds (for instance Benzene, Benzole, Toluene), Polycyclic Aromatic Hydrocarbons (PAHs) (for instance Benzo(a)pyrene), Halogenated Polycyclic Organics such as Dioxins and Furans (PCDDs and PCDFs) are other pollutants impacting the environment and health.

It is thus useful to have reactants capable of absorbing and retaining large amounts of metals and organic pollutants for treating industrial effluents, in particular gaseous or liquid effluents and wastewaters originating from treatment plants, before the release thereof into nature. This avoids in particular the dispersion of such pollutants in the atmosphere that are detrimental to human health or to the natural environment, and also avoids their accumulation on fields, on crops, in rivers or in natural aquifer waters.

Examples of a problem linked to metals and organic pollutants is the combustion of: organic materials, coal, fuel, wastes, especially household or industrial wastes, producing a vaporization of metals and heavy metals, these vapours being entrained in the combustion flue gases Those combustions produce also in more or less quantities organic pollutants including; VOC, aromatic compounds, PAHs, Dioxins and Furans. Such pollutants may be controlled by a proper temperature and time of combustion and/or post combustion of gasses, and a proper cooling to prevent chemical poly-condensation of such organics. Though such controls are costly, and sometimes not sufficient, to achieve the very low limits of emission regulations needed to minimize properly environmental and health impacts.

To avoid contaminating the environment, it is necessary to provide flue gas treatment processes capable of carrying out effective scrubbing of metals and organic pollutants. The toxic substances removed from the flue gas when it is purified are found in a residue which itself must often be treated before being valorized, discharged, or recycled. Indeed such residue, which contains the metals removed from the flue gas, when subjected, for example, to the action of rain that is acidic when discharged, frequently releases some of the metals or pollutant organics that it contains into the environment. This can then cause pollution of the subsoil. It is therefore essential that the metals, in particular heavy metals, and organic pollutants be immobilized in the residue.

A known technology for absorbing metals or VOC in fumes mitigation is the use of active carbon powder by dry injection or spray drying in hot fumes. Such technologies present a strong disadvantage when peaks of pollutant are to be mitigated. Indeed operators of gas treatment units are then obliged to increase the amount of active carbon. Higher quantities of highly divided active carbon particles in hot gasses often lead to the burning of such reactants or adsorbent on filtration media, or in storage and handling logistics on reactant lines or dust removal lines. This leads in particular to use expensive ATEX equipments adapted to explosive atmospheres. Moreover, when using bag filters technology, burning of active coal on the surface of the filtration clothes in particular when comprising fusible materials (such as PTFE, polyamide, etc. . . . ) is an issue as such bags replacement is expensive.

Therefore there exists a need for improved gas mitigation processes for the control of gas species pollutant emissions from gas streams, in particular for metals and VOC.

The inventors of present invention have also surprisingly observed that the calcium-phosphate reactant (reagent) particle comprising apatite obtainable by the herein described reactant manufacturing process, have improved dispersion characteristics in gas compared to prior known phosphate based reactants or known active carbon, and a good porosity when used with gas filtration equipments.

### SUMMARY OF INVENTION

The invention relates to a process for treating a gas contaminated by at least one element selected from the group consisting of metals, in particular heavy metals, organic compounds, and combinations thereof, according to which a calcium-phosphate reactant (reagent) particle comprising apatite is brought into contact with the contaminated gas at a temperature of at least 30° C. and preferably at most 1100° C. The gas temperature may be at least 100° C., or at least 120° C., or at least 140° C., or at least 150° C., or at most 300° C., or at most 250° C., or at most 200° C.

In particular the invention relates to a process for treating a gas stream contaminated by at least one element, said gas stream presenting peaks of concentration of the at least one element in the gas stream versus time, wherein the at least one element is selected from the group consisting of metals, organic compounds, and combinations thereof,

according to which a calcium-phosphate reactant (reagent) particle comprising apatite is brought into contact with the contaminated gas stream at a temperature of at least 30° C. and preferably at most 1100° C.,
and said process comprising:
(a) measuring the at least one element concentration in the contaminated gas stream,
(b) injecting in the contaminated gas stream an alkaline compound particle selected among the list of: sodium bicarbonate, sodium carbonate, trona, quick lime, hydrated lime, lime stone and any mixture thereof,
(c) injecting the calcium-phosphate reactant at a given flow-rate in the contaminated gas stream,
(d) removing the calcium-phosphate reactant and the at least one alkaline compound that have been in contact with the contaminated gas stream from the gas stream on a filter to obtain a treated gas stream,
(e) measuring the at least one element concentration in the treated gas stream,
(f) increasing/(or)decreasing the flow-rate of the calcium-phosphate reactant injected at step (c) when the measured concentration of the at least one element at step (a) respectively increases/(or) decreases during peaks of concentration so that to maintain on the filter at least a part of the calcium-phosphate reactant still able to adsorb the at least one element, and so that to maintain the at least one element concentration in the treated gas stream below a targeted concentration value.

In present process, the at least one element to be mitigated in flue-gas stream is advantageously selected from the group consisting of: Al, Ag, As, Ba, Be, Bi, Ce, Co, Cd, Cu, Cr, Fe, Hf, Hg, La, Li, Mg, Mn, Mo, Ni, Pb, Pd, Rb, Sb, Se, Sn, Sr, Th, Ti, U, V, Y, Zn, Zr, VOC, aromatic compounds, PAHs, dioxins, furans, or any mixture thereof.

The calcium-phosphate reactant compositions disclosed herein comprises apatite useful for capture of above listed pollutants. Generally the sorbent compositions consist of or consist essentially of one or more calcium-phosphate compounds, as described herein. In other embodiments, the calcium-phosphate reactant may optionally include one or more additional components different from calcium-phosphate compounds. The sorbent compositions may include various combinations of sorbent compounds and associated compositions. The calcium-phosphate reactant can be in various forms and proportions relative to the one or more additional components of the compositions. In certain embodiments, the calcium-phosphate reactant compositions can stand alone, be further modified by chemical and/or physical means, or integrated into other products (e.g., consumer or industrial products).

The calcium-phosphate reactant compositions generally comprise at least 50, or at least 60, or at least 75, or at least 80, or at least 95 percent by weight of apatite. The apatite is generally in the present invention in crystalline form or in vitreous form.

In an advantageous embodiment of the invention, the calcium-phosphate reactant is obtained or may be obtainable by the process of any items 1 to 16 of this patent application described herein below.

The calcium-phosphate reactant is advantageously a reactant according to any items 17 to 30 of this patent application described herein below.

In the process, it is particularly advantageous that an alkaline compound particle comprising sodium bicarbonate, sodium carbonate, sodium sesquicarbonate (trona), quick lime, hydrated lime, lime stone and any mixture thereof, may be also brought into contact with the contaminated gas. The weight ratio of the calcium-phosphate reactant to said alkaline compound brought into contact with the contaminated gas may be at least 0.001, or at least 0.005, or at least 0.010, or at least 0.020, or at least 0.030, or at least 0.045. The weight ratio of the calcium-phosphate reactant to alkaline compound brought into contact with the contaminated gas may be at most 1.00, or at most 0.50, or at most 0.40, or at most 0.30.

The calcium-phosphate reactant is brought into contact with the contaminated gas as an aqueous suspension (D), or as a wet solid (D′), or as a pulverulent solid (D″), preferably a pulverulent solid (D″).

A first advantage of the present invention is that treatment of gas stream contaminated in metals or organic compounds may be realized without or with minimized active carbon injection, reducing sensitively the risks associated to flamable and fine reactants in hot gas stream.

A second advantage of the present invention is that, when the gas stream is contaminated with variable concentrations with time of contaminants such as metals or organic compounds, the present process enables to keep low values targeted or low values to be achieved according local regulations (for instance in Europe the European directive n° 2000/76/CE of Dec. 4, 2000 for incineration of dangerous and non-dangerous wastes or European directive n° 2010/75/EU of Nov. 24, 2010 on industrial emissions and pollution prevention). The process is particularly useful for power plants or industrial process burning carbonaceous materials of different sources or of variable compositions. And more particularly when frequent peaks of concentrations are observed (one or several per hours or per few hours) of short duration of time (a few minutes to a few tens of minutes) with values increase of, for instance +25% or, +50%, or up to ten times the average concentration calculated on a longer time (for instance 10 minutes or a few hours to a few days) of the contaminant.

A third advantage of the present invention is that the calcium-phosphate reactant according the invention, presents when in dried powder (as pulverulent solid) an improved flowability and dispersion ability in gas streams compared to previous calcium phosphate of prior art (in particular the ones described in WO 2008095921 from SOLVAY, using a gel step during the manufacture of the calcium-phosphate reactant).

A fourth advantage of the present invention is that alkaline compound in association with calcium-phosphate reactants demonstrate an effective synergy to mitigate contaminants targeted by present invention. Indeed, alkaline compounds injection followed by a filtration step of the gas streams, reduces significantly (typically 30 to 80%, or more) metals, heavy metals, and organics (in particular hydrophobic organics and acidic organic compounds).

A fifth advantage of the present invention when the treatment of the flue gas comprises downstream after step (d) a selective catalytic reduction (SCR) DeNOx equipment, is the improved operation time of the catalyst. Indeed several metals vapors, including mercury, poisoned the catalyst that becomes ineffective and has to be replaced. This operation is very expensive linked to the cost of catalyst replacement and the necessity to stop the industrial line generating the gas stream and to restart it.

A sixth advantage of the present invention is the good synergy of the reacted calcium phosphate reactant and the reacted alkaline compounds after gas treatment (residual solids recovered after separation step (d)) for their reuse and their recycling to provide new raw materials. Indeed residual solids after gas treatment comprise generally: NaCl, Na2SO4, CaCl2, CaO.CaCl2, CaSO4, and mixtures thereof, and present decreased heavy metals or organics concentrations in brines when solubilized in aqueous solutions, as said contaminants remain adsorbed in calcium-phosphate reactant.

A seven advantage of the present invention relates to water containing calcium phosphate reactant particles. Without being linked to a scientific explanation, the inventors of present invention believe that the presence of water in such reactant induces a cooling of the particles when released in hot gasses (endothermic reaction), therefore limiting the temperature increase of the calcium phosphate reactant particle in hot gasses and therefore increasing the condensation or adsorption of ionized or metallic (non-ionized or non-oxidized) elements on such calcium-phosphate particles comprising water.

### BRIEF DESCRIPTION OF DRAWING

FIG. 1 is a schematic of a treatment process according to an embodiment of the present invention, wherein an alkaline compound 2 and a particulate reactant containing apatite 3 are injected into a flue gas effluent before a solid particle separator 4.

### DEFINITIONS

The term “peak of concentration” in present specification is intended to mean an increase and then a decrease of concentration versus time of one element or one contaminant. Preferably the peak of concentration is relative to an increase of at least 25% of the concentration above the mean value of the concentration of past ten minutes.

The term “trona” is intended to mean a mineral containing at least 60%, preferably at least 80%, more preferably at least 90%, even more preferably at least 95% by weight of sodium sesquicarbonate (NaHCO3.Na2CO3.2H₂O). The remainder of the mineral generally consists of clays, or carbonate of calcium or magnesium.

In the present specification, the choice of an element from a group of elements also explicitly describes:
the choice of two or the choice of several elements from the group,
the choice of an element from a subgroup of elements consisting of the group of elements from which one or more elements have been removed.

In addition, it should be understood that the elements and/or the characteristics of a process or a use, described in the present specification, can be combined in all ways possible with the other elements and/or characteristics of the process, or of use, explicitly or implicitly, this being without departing from the context of the present specification.

In the passages of the present specification that will follow, various embodiments or items of implementation are defined in greater detail. Each embodiment or item of implementation thus defined can be combined with another embodiment or with another item of implementation, this being for each mode or item unless otherwise indicated or clearly incompatible when the range of the same parameter of value is not connected. In particular, any variant indicated as being preferred or advantageous can be combined with another variant or with the other variants indicated as being preferred or advantageous.

In the present specification, the description of a range of values for a variable, defined by a bottom limit, or a top limit, or by a bottom limit and a top limit, also comprises the embodiments in which the variable is chosen, respectively, within the value range: excluding the bottom limit, or excluding the top limit, or excluding the bottom limit and the top limit.

In the present specification, the description of several successive ranges of values for the same variable also comprises the description of embodiments where the variable is chosen in any other intermediate range included in the successive ranges. Thus, for example, when it is indicated that “the magnitude X is generally at least 10, advantageously at least 15”, the present description also describes the embodiment where: “the magnitude X is at least 11”, or also the embodiment where: “the magnitude X is at least 13.74”, etc.; 11 or 13.74 being values included between 10 and 15.

The term “comprising” includes “consisting essentially of” and also “consisting of”.

In the present specification, the use of “a” in the singular also comprises the plural (“some”), and vice versa, unless the context clearly indicates the contrary. By way of example, “a mineral” denotes one mineral or more than one mineral.

If the term “approximately” is used before a quantitative value, this corresponds to a variation of ±10% of the nominal quantitative value, unless otherwise indicated.

### DETAILED DESCRIPTION OF INVENTION

### Reactant

The reactant used in the present invention preferably consists of particles, the mean diameter D50 of which is greater than 10 μm, in general greater than 20 μm, or even greater than 50 μm. However, this mean diameter of the reactant is in general preferably less than 200 μm, or even less than 150 μm. This makes it possible to limit the stirring powers to prevent the particles of reactant from needing high velocities of flue gases to be treated at the injection points of the reactant for the treatment of the flue gases.

Moreover the reactant may have a particularly high specific surface (at least 110 m²/g, or more) and particular high adsorption capacity of metals, and organic molecules.

For comparison, for instance natural apatite found in Maroco have specific surfaces of about 16 m²/g.

The reactant particles are preferably composed of calcium phosphate, the structure of which is intermediate between tricalcium phosphate and calcium phosphate hydroxyapatite. These particles then evolve very rapidly towards an apatite structure. Such reactant particles are composed on their surface of plate like crystallites, of thickness of a few nano-meters (nm).

The reactant used in the present invention may further have a remarkably low solubility of the phosphates contained in the reactant particles.

The particles of calcium phosphate reactant used in the present invention in general comprise at least 50% calcium phosphate, advantageously at least 60% and more advantageously still at least 80% calcium phosphate. The balance to 100% in general comprises: water, of the order of from 0 to 20%, advantageously from 5% to 20%, calcium carbonate from 0 to 20%, advantageously from 5% to 20%, calcium hydroxide from 0 to 20%, advantageously from 1% to 4%. The particles of calcium phosphate reactant may additionally contain residual compounds originating from the use of the raw materials in the process such as: CaCl₂, Ca(NO₃)₂, sands or clays; these constituents are in general less than 5% by weight, advantageously less than 2% by weight.

The term “apatite” denotes a family of mineral compounds, the chemical formula of which can be written in the following general form:

Me₁₀(XO₄)₆Y₂

In this formula, Me generally represents a divalent cation (Me²⁺), XO₄ a trivalent anionic group (XO₄³) and Y a monovalent anion (Y).

Calcium phosphate hydroxyapatite Ca₁₀(PO₄)₆(OH)₂ crystallizes in the space group of the hexagonal system. This structure consists of a close-packed quasi-hexagonal stack of XO₄ groups, forming two types of parallel tunnels.

The existence of these tunnels gives apatites chemical properties akin to those of zeolites. Vacancies may also be created either by the departure of anions and cations, or by the presence of cations or anions of different valency. Apatites therefore appear to be particularly stable structures which may tolerate large gaps in their composition.

Hydroxyapatite should not be confused with tricalcium phosphate (TCP), which has a similar weight composition: Ca₃(PO₄)₂. The Ca/P molar ratio of TCP is 1.5 whereas it is 1.667 for hydroxyapatite. Industrial apatites sold as food additives or mineral fillers are, as a general rule, variable mixtures of TCP and hydroxyapatite.

Other salts of calcium and phosphate, including TCP, do not have the same properties as hydroxyapatite. Although TCP can also react with heavy metals, hydroxyapatite is more advantageous as it can enclose metals in the form of an insoluble, and therefore relatively inert, matrix.

### Process for Making the Calcium-Phosphate Reactant

The process for producing the calcium phosphate reactant may comprise:
in a first step, use is made of a source of calcium and a source of phosphate ions in water, in a molar ratio that is adjusted so as to obtain a Ca/P molar ratio of between 0.5 and 1.6, and the source of calcium is reacted with the phosphate ions at a pH of between 2 and 8, in order to obtain a suspension (A) of calcium phosphate, and
in a second step, added to the suspension (A) are an alkaline compound comprising hydroxide ions in order to set a pH of more than 8, preferably of at least 8.5, and an additional source of calcium in order to obtain a suspension (B) of calcium phosphate reactant having a Ca/P molar ratio of more than 1.6.

In the process of manufacture, the source of calcium to make the calcium-phosphate reactant advantageously comprises calcium carbonate, or calcium oxide, or calcium hydroxide, or calcium chloride, or calcium nitrate, or calcium acetate. The source of calcium is more advantageously a limestone, or a mixture of limestone and calcium oxide or hydroxide. More advantageously, the source of calcium is in the form of powder or aqueous suspension of powder and the powder is selected from: calcium carbonate, calcium oxide, calcium hydroxide, or a mixture thereof, and the powder has a mean particle size of less than 300 μm.

It is advantageous for the source of calcium selected from calcium carbonate, calcium oxide, calcium hydroxide or mixtures thereof to be in the form of a powder or aqueous suspension of powder, and to have a small particle size. In one recommended variant, the mean diameter of the particles of the powder is less than 300 μm, advantageously less than 200 μm and preferably less than 100 μm. The mean diameter in question is the D50, that is to say the diameter such that 50% by weight of the particles have a diameter less than said value.

In the process of manufacture, various sources of phosphate ions to make the calcium-phosphate reactant may be used, in particular:
phosphoric acid,
or a dihydrogen phosphate salt such as a sodium, potassium or ammonium dihydrogen phosphate salt, preferably a sodium dihydrogen phosphate salt,
or a monohydrogen phosphate salt such as a sodium, potassium or ammonium monohydrogen phosphate salt, preferably a sodium monohydrogen phosphate salt.

In the process of manufacture to make the calcium-phosphate reactant, phosphoric acid is preferred due to its greater availability and lower cost compared to dihydrogen and monohydrogen phosphate salts.

In the process of manufacture to make the calcium-phosphate reactant, in the first step the Ca/P molar ratio is in particular:
between 0.50 and 1.35, preferably between 0.70 and 1.30,
or: between 1.4 and 1.6, preferably between 1.4 and 1.5.

During the first step where calcium and phosphate are used in a Ca/P molar ratio of between 0.5 and 1.6 and where they are reacted at a pH between 2 and 8, the compounds formed in the suspension (A) are a mixture of monocalcium phosphate (MCP) having the weight formula Ca(H₂PO₄)₂, of dicalcium phosphate (DCP) having the weight formula CaHPO₄, or the hydrate thereof, brushite, having the weight formula CaHPO₄.2H₂O, and of octacalcium having the weight formula Ca₈H₂(PO₄)₆.6.5H₂O. The Ca/P molar ratios are respectively for these compounds: 0.5 (MCP), 1.0 (DCP and brushite), 1.33 (octacalcium).

In order to promote, in the first step, the formation of MCP and DCP, a Ca/P ratio of between 0.50 and 1.35, preferably between 0.7 and 1.30, is favoured. This Ca/P molar ratio is particularly advantageous when the source of calcium from the first step comprises calcium carbonate, and the source of phosphate is phosphoric acid (H₃PO₄) or is a dihydrogen phosphate salt such as a sodium or potassium or ammonium salt. Specifically, this makes it possible to obtain a rapid attack of the calcium carbonate and a rapid degassing of the CO₂.

In addition to calcium carbonate, the source of calcium may comprise calcium oxide, or calcium hydroxide, or calcium chloride, or calcium nitrate, or calcium acetate.

In order to promote, in the first step, the formation of DCP and octacalcium, a Ca/P ratio of between 1.4 and 1.6, preferably between 1.4 and 1.5, is favoured. This molar ratio is advantageous when use is made of a source of calcium having less than 30% by weight of carbonate, such as preferably: calcium oxide, or calcium hydroxide, or calcium chloride, or calcium nitrate, or calcium acetate.

In the process of manufacture to make the calcium-phosphate reactant, in the first step, the source of calcium and the phosphate ions are in general reacted for at least 0.1 hour, preferably at least 0.5 hour. It is not useful to react them over excessively long durations. Advantageously, the source of calcium and the phosphate ions are reacted for at most 4 hours, more advantageously at most 2 hours, or even at most 1 hour. For example, a duration of 1 hour at pH 5 already enables a good reaction of the calcium and the phosphate ions, and makes it possible to sufficiently release the CO₂ when a source of calcium comprising calcium carbonate is used, before moving on to the second step.

In the process of manufacture to make the calcium-phosphate reactant, in the second step, the suspension (B) of calcium phosphate reactant in general has a Ca/P molar ratio of at most 5, preferably of at most 3, more preferably still of at most 2.

In the process of manufacture to make the calcium-phosphate reactant, it is advantageous, in the second step, for the alkaline compound used, that comprises hydroxide ions, to be sodium hydroxide and/or calcium hydroxide.

In the process of manufacture to make the calcium-phosphate reactant, it is particularly advantageous for the additional source of calcium to be selected from calcium chloride, calcium nitrate, or calcium acetate, preferably calcium chloride, and for it to be added in addition to the alkaline compound, in order to finely adjust the Ca/P ratio and in order to limit the concentration of phosphorus element in the aqueous solution (C) of the suspension (B) to at most 5 mmol, advantageously to at most 0.5 mmol, more advantageously to at most 0.05 mmol of phosphorus element per litre of aqueous solution (C). Specifically, this makes it possible, coupled with the use of hydroxide ions for setting the pH of the second step, to limit the losses of phosphates in the process waters.

In the process of manufacture to make the calcium-phosphate reactant, in general, the stirring and the density of suspension, in the second step and advantageously also in the first step, are adjusted in order to avoid the appearance of a calcium phosphate gel having a viscosity of at least 200 cps. The viscosity of the calcium phosphate reactant suspension (B) in the second step of the process of present invention is typically about 10 cps (mPa·s). Specifically, the production of a gel, even in the presence of the second step, results in particles of calcium phosphate reactant of small particle size being produced, with weight-mean D50 values of less than 10 μm, which is a disadvantage for certain applications of liquid effluents such as those that use a sludge blanket.

The suspended solids density of the suspension (A) in the first step is in general at most 20%. The suspended solids density of the suspension (B) in the second step is in general at most 15%. The suspended solids density of the suspension (A) and or of the suspension (B) is advantageously at least 10%. It has been indeed observed that a too low density of suspension decreases the efficacy of the produced reactant particles in heavy metal adsorption (in particular on Zn, Cu, Ni). Moreover a too low density of suspension induces longer time of water separation when decantation or filtration is used in the process.

In the process of manufacture to make the calcium-phosphate reactant, the stirring of the suspension during the first and second steps corresponds generally to a stirring dissipated energy in the reactors volume of at least 0.2 and at most 1.5 kW/m³, preferably at least 0.5 and at most 1.0 kW/m³.

In a first embodiment of the process of manufacture to make the calcium-phosphate reactant, the first step is carried out at a temperature of less than 50° C., preferably at most 45° C., or at most 40° C. This makes it possible to obtain a calcium phosphate reactant at the end of the second step in the form of particles of large to medium particle size and having a high specific surface area. The process may manufacture in particular a particle of calcium phosphate reactant by this first embodiment, comprising at least 60% by weight of hydroxyapatite, and having a mean size of at least 30 μm, preferably of at least 50 μm and having a specific surface area of at least 50 m²/g, preferably of at least 110 m²/g, and comprising at least 2%, preferably at least 5%, and more preferably at least 6% by weight of hydroxide ions.

In a second embodiment of the process of manufacture to make the calcium-phosphate reactant, the first step is carried out at a temperature of at least 50° C., preferably of at least 55° C., or of at least 60° C. This makes it possible to obtain a calcium phosphate reactant in the second step in the form of particles of small particle size and having a lower specific surface area. The process may manufacture in particular a particle of calcium phosphate reactant obtained by the process according to this second embodiment, comprising at least 60% by weight of hydroxyapatite, and having a mean size of at most 30 μm, preferably of at most 20 μm and having a specific surface area of at least 15 m²/g, preferably of at least 50 m²/g, and having a content of hydroxide ions of greater than 2% by weight, preferably greater than 3.5% by weight, and more preferably greater than 4% by weight.

In the first or second embodiment of the process of manufacture, it is advantageous for the second step to be carried out at a temperature of at least 45° C., preferably of at least 55° C., or of at least 60° C., or of at least 80° C. Specifically, this makes it possible to rapidly convert the calcium phosphate compounds from the first step into the calcium phosphate reactant according to the invention, with a good fixation of the hydroxide ions at the core and at the surface of the calcium phosphate reactant, and to more rapidly consume the phosphates from the solution of the suspension (B). Advantageously, the second step of the manufacture process is carried out at a temperature of at least 45° C., preferably of at least 55° C., or of at least 60° C., or of at least 80° C., for a duration of at least 0.1 to 0.5 hour. In general, the addition of the alkaline compound comprising hydroxide ions in order to set the pH of the second step, and of the additional source of calcium in order to obtain a suspension (B) of calcium phosphate reactant having a Ca/P molar ratio of greater than 1.6 last no more than 4 hours, advantageously no more than 2.5 h: at higher temperature such as at 50 or at 60° C. generally one hour is sufficient, as at 40° C. the alkaline compound addition to set the pH of the second step is generally longer: and about 2.5 hours are needed. Preferably, the alkaline compound addition is stopped when the pH remains at the set value for at least 15 minutes. Advantageously, once the additions of hydroxide ions for setting the pH of the second step, and the addition of the additional source of calcium are completed, the suspension (B) is left to cool for 1 to 24 hours, preferably at least 10 hours, down to ambient temperature. This makes it possible to mature the calcium phosphate reactant and to reduce the residues of MCP/DCP or brushite, or of octacalcium (precipitated during the first step), into hydroxyapatite and into calcium phosphate and calcium hydroxide complexes, within the suspension (B).

Optionally, in the manufacture process, at the end of the second step, the suspension (B) comprises an aqueous solution (C) and calcium phosphate reactant particles, and
in a third step, a portion of the aqueous solution (C) is separated from the suspension (B) in order to obtain an aqueous suspension (D) comprising at least 18% and at most 50% of calcium phosphate reactant particles, or in order to obtain a wet solid (D′) comprising at least 50% and at most 80% of calcium phosphate reactant particles, or a pulverulent solid (D″) comprising at least 80% and at most 95% of calcium phosphate reactant particles and at least 5% and at most 20% of water.

### Treatment Process Using Calcium Phosphate Reactant Particle

Consequently, the present invention also relates to a flue gas treatment process using an aqueous suspension (D) comprising at least 2% and at most 50% of calcium phosphate reactant particle, or a wet solid (D′) comprising at least 50% and at most 80% of calcium phosphate reactant particle obtained by the manufacture process described herein, or a pulverulent solid (D″) comprising at least 80% and at most 95% of calcium phosphate reactant particle obtained by the manufacture process described herein and at least 5% and at most 20% of water.

The calcium phosphate reactant obtained by the manufacture process described herein may be effective for treating substances contaminated by heavy metals and/or organic compounds, in particular contaminated by at least one heavy metal.

The present invention relates also to a process for treating a gas contaminated by at least one element selected from the group consisting of heavy metals, organic compounds, and combinations thereof, according to which the gas is brought into contact with the calcium phosphate reactant particle comprising apatite, in order that at least one portion of the heavy metal(s) and/or organic compound(s) is adsorbed by the particulate calcium phosphate reactant.

In the treatment method according to the invention, the contaminated gas may be a flue gas containing at least one heavy metal or organic compound such as Cd, Pb, Zn, Hg, Se, As, and according to which the calcium phosphate reactant particle is dispersed in the flue gas, the flue gas being at a temperature of at least 30° C., or of at least 100° C., of at least 120° C., or of at least 150° C., the resulting mixture then being subjected to a separation in order to obtain a resulting solid and a flue gas partially purified of heavy metal(s) or organic compound(s). The flue gas may be at a temperature of at most 1110° C., or of at most 300° C., of at most 250° C., or of at most 200° C.

In the treatment method according to the invention, the contaminated gas may contain heavy metals or organic compounds such as: Al, Ag, As, Ba, Be, Bi, Ce, Co, Cd, Cu, Cr, Fe, Hf, Hg, La, Li, Mg, Mn, Mo, Ni, Pb, Pd, Rb, Sb, Se, Sn, Sr, Th, Ti, U, V, Y, Zn, Zr, VOC, aromatic compounds, PAHs, dioxins, furans, or any mixture thereof, according to which the calcium phosphate reactant particle is contacted with the a flue gas effluent for a sufficient time so that the calcium phosphate reactant adsorbs at least a portion of the heavy metal(s) and/or organic compound(s) and the resulting mixture is subjected to a separation in order to produce a treated gas which is partially purified of heavy metals or organic compounds, on the one hand, and the calcium phosphate reactant particle loaded with the heavy metal(s) and/or organic compound(s) that is removed from the treated gas. Preferably, the calcium phosphate reactant particle is used with the contaminated gas in a contact reactor. The contact time between the calcium phosphate reactant and the liquid effluent is in general at least one minute, advantageously at least 15 minutes, more advantageously at least 30 minutes, even more advantageously at least one hour.

The effectiveness of the treatment of metallic elements may be monitored by comparing the concentrations of the elements upstream (in the gas effluent) and downstream of the treatment (in the partially treated gas), for example by an automatic analyser or by sampling and analysis. The calcium phosphate reactant charge of the contact reactor may be in general regularly renewed in portions, for example, by partial purging of the calcium phosphate reactant loaded with contaminating element(s), and by adding fresh calcium phosphate reactant to the contact reactor. Such a process thus ensures a “chemical polishing” of the gas effluents.

In the treatment method according to the invention, the contaminated substance may be any gas contaminated by heavy metal(s) or organic compound(s) according to which the calcium phosphate reactant, or the aqueous suspension (D) or the wet solid (D′) or the pulverulent solid (D″) of calcium phosphate reactant is injected into the gas for a sufficient time so that the calcium phosphate reactant adsorbs at least a portion of the heavy metal(s) or organic compound(s).

In particular the present invention relates to the following embodiments:

Item 1. Process for producing a calcium phosphate reactant, according to which:
in a first step, use is made of a source of calcium and a source of phosphate ions in water, in a molar ratio that is adjusted so as to obtain a Ca/P molar ratio of between 0.5 and 1.6, and the source of calcium is reacted with the phosphate ions at a pH of between 2 and 8, in order to obtain a suspension (A) of calcium phosphate, and
in a second step, added to the suspension (A) are an alkaline compound comprising hydroxide ions in order to set a pH of more than 8, preferably of more than 8.5, preferably of at least 9, or of at least 10, and an additional source of calcium in order to obtain a suspension (B) of calcium phosphate reactant having a Ca/P molar ratio of more than 1.6.

Item 2. Process according to the preceding item, in which in the second step the pH is set between 8 and 10.5, preferably between 8.5 and 10.

Item 3. Process according to the preceding items, in which the source of calcium comprises calcium carbonate, or calcium oxide, or calcium hydroxide, or calcium chloride, or calcium nitrate, or calcium acetate.

Item 4. Process according to any one of the preceding items, in which the source of phosphate ions is phosphoric acid.

Item 5. Process according to any one of items 1 to 3, in which the source of phosphate ions is a dihydrogen phosphate salt such as a sodium, potassium or ammonium dihydrogen phosphate salt, preferably a sodium dihydrogen phosphate salt.

Item 6. Process according to any one of items 1 to 3, in which the source of phosphate ions is a monohydrogen phosphate salt such as a sodium, potassium or ammonium monohydrogen phosphate salt, preferably a sodium monohydrogen phosphate.

Item 7. Process according to any one of the preceding items, wherein in the second step, the suspension (B) of calcium phosphate reactant has a Ca/P molar ratio of at most 5, preferably of at most 3, more preferably still of at most 2.

Item 8. Process according to any one of the preceding items, in which, in the first step, the Ca/P molar ratio is:
between 0.50 and 1.35, preferably between 0.70 to 1.30,
or: between 1.4 and 1.6, preferably between 1.4 and 1.5.

Item 9. Process according to any one of the preceding items, wherein the source of calcium is in the form of powder or aqueous suspension of powder and the powder is selected from: calcium carbonate, calcium oxide, calcium hydroxide, or a mixture thereof, and the powder has a mean particle size of less than 300 μm.

Item 10. Process according to any one of the preceding items, in which the stirring and the density of suspension, in the second step and advantageously also in the first step, are adjusted in order to avoid the appearance of a calcium phosphate gel having a viscosity of at least 100 or at least 200 cps.

Item 11. Process according to any one of the preceding items, in which, in the second step, the alkaline compound used that comprises hydroxide ions is sodium hydroxide and/or calcium hydroxide and/or magnesium hydroxide.

Item 12. Process according to any one of the preceding items, in which, in the second step, the additional source of calcium is selected from calcium chloride, calcium nitrate, or calcium acetate, preferably calcium chloride, and is added in addition to the alkaline compound, in order to finely adjust the Ca/P molar ratio and limit the concentration of phosphorus element in the aqueous solution (C) of the suspension (B) to at most 5 mmol, advantageously to at most 0.5 mmol, more advantageously to at most 0.05 mmol of phosphorus element per litre of aqueous solution (C).

Item 13. Process according to any one of the preceding items, in which the first step is carried out at a temperature of less than 50° C., preferably of at most 45° C., more preferably of at most 40° C.

Item 14. Process according to any one of items 1 to 12, in which the first step is carried out at a temperature of at least 50° C., preferably of at least 55° C., more preferably of at least 60° C.

Item 15. Process according to any one of the preceding items, in which the second step is carried out at a temperature of at least 40° C., preferably of at least 45° C., more preferably of at least 55° C., even more preferably of at least 60° C., or of at least 80° C.

Item 16. Process according to any one of the preceding items wherein at the end of the second step, the suspension (B) comprises an aqueous solution (C) and calcium phosphate reactant particles, and
in a third step, a portion of the aqueous solution (C) is separated from the suspension (B) in order to obtain an aqueous suspension (D) comprising at least 18% and at most 50% of calcium phosphate reactant particles, or to obtain a wet solid (D′) comprising at least 50% and at most 80% of calcium phosphate reactant particles, or to obtain a pulverulent solid (D″) comprising at least 80% and at most 95% of calcium phosphate reactant particles and at least 5% and at most 20% of water.

Item 17. Particle of calcium phosphate reactant obtainable by the process according to item 13, comprising at least 60% by weight of hydroxyapatite, and having a mean size of at least 30 μm.

Item 18. Particle of calcium phosphate reactant according to the preceding item comprising at least 70%, preferably at least 75%, more preferably at least 80% by weight of hydroxyapatite.

Item 19. Particle of calcium phosphate reactant according to Items 17 or 18 having a mean size of at least 50 μm.

Item 20. Particle of calcium phosphate reactant according to items 17 to 19 having a specific surface area of at least 50 m²/g, more preferably of at least 110 m²/g, even more preferably of at least 120 m²/g, or of at least 140 m²/g, or at least 160 m²/g.

Item 21. Particle of calcium phosphate reactant according to Items 17 or 19 having a mean size of at most 200 μm, preferably of at most 100 μm, more preferably of at most 70 μm.

Item 22. Particle of calcium phosphate reactant according to items 17 to 21 comprising at least 2%, preferably at least 5%, and more preferably at least 6% by weight of hydroxide ions.

Item 23. Particle of calcium phosphate reactant according to items 17 to 22 covered with plate-like crystallites, and wherein the plate-like crystallites have a thickness of at most 25 nm, preferably of at most 20 nm, more preferably of at most 10 nm.

Item 24. Particle of calcium phosphate reactant according to item 23 wherein the thickness of plate-like crystallites is at least 1 nm, preferably at least 2 nm, more preferably at least 4 nm.

Item 25. Particle of calcium phosphate reactant according to Items 17 to 24 and having a mean size of at least 50 μm.

Item 26. Particle of calcium phosphate reactant according to Items 17 to 25 wherein the solubilized phosphate of 10 g of such particles stirred in 90 mL of water during 24 hours with a lab magnetic barrel, then filtrated on a 0.45 μm nitrocellulose membrane, is less than 10 mg PO4/L of water.

Item 27. Aqueous suspension (D) comprising at least 25% and at most 50% of calcium phosphate reactant particles according to item 17 to 26, preferably obtainable from the process of item 16.

Item 28. A pulverulent solid (D″) comprising at least 80% and at most 95% of calcium phosphate reactant particles according to item 17 to 26 and comprising at least 5%, preferably at least 6%, more preferably at least 10%, even more preferably at least 15% of water, advantageously obtainable from the process of item 16.

Item 29. A pulverulent solid (D″) according to item 28 comprising at most 20% of water.

Item 30. Particle of calcium phosphate reactant obtainable by the process according to item 14, comprising at least 60% by weight of hydroxyapatite, and having a mean size of at most 30 μm, preferably of at most 20 μm and having a specific surface area of at least 15 m²/g, preferably of at least 50 m²/g, and having a content of hydroxide ions of greater than 2% by weight, preferably greater than 3.5% by weight, and more preferably greater than 4% by weight.

Item 31. Method for treating a gas effluent contaminated with heavy metal(s) and/or organic compound(s), according to which the calcium phosphate reactant obtained by the process of any one of items 1 to 16 or the calcium phosphate reactant of items 17 to 26, or the aqueous suspension (D) of item 27, or the pulverulent solid (D″) of items 28 to 29, is injected into the gas effluent for a sufficient time so that the calcium phosphate reactant adsorbs at least a portion of the heavy metal(s) or organic compound(s) and the treated gas loaded with reactant particles is subjected to a separation in order to produce a gas partially purified of heavy metal(s) or organic compound(s), on the one hand, and the calcium phosphate reactant loaded with heavy metal(s) or organic compound(s) that is/are removed.

Item 32. Treatment method according to item 31, in which the calcium phosphate reactant or the aqueous suspension (D), as wet solid (D′), or the pulverulent solid (D″) is used with the gas effluent;

with a contact time between the calcium phosphate reactant and the effluent of at least 15 minutes.

Item 101. Process for treating a gas contaminated by at least one element selected from the group consisting of heavy metals, organic compounds, and combinations thereof, according to which a calcium-phosphate reactant (reagent) particle comprising apatite is brought into contact with the contaminated gas at a temperature of at least 30° C. and preferably at most 1100° C.

Item 102. Process according to item 101 wherein the gas temperature is at least 100° C., or at least 120° C., or at least 150° C.

Item 103. Process according to item 101 or 102 wherein the gas temperature is at most 300° C.

Item 104. Process according to any one of the items 101 to 103 wherein the gas temperature is at most 250° C.

Item 105. Process according to any one of the items 101 to 104 wherein the gas temperature is at most 200° C.

Item 106. Process according to any one of the items 101 to 105 wherein at least one element selected from the group consisting of heavy metals, organic compounds, and combinations thereof is selected among the list of: Al, Ag, Ba, Be, Ce, Co, Cd, Cu, Cr, Fe, Hg, La, Li, Mo, Ni, Pb, Pd, Rb, Sb, Se, Sn, Th, Ti, U, V, Y, Zn, dioxins, or any mixture thereof.

Item 107. Process according to any one of the items 101 to 106 wherein the calcium-phosphate reactant is obtainable by the process of any items 1 to 16.

Item 108. Process according to any one of the item 101 to 107 wherein the calcium-phosphate reactant is a reactant according to any items 17 to 30.

Item 109. Process according to any one of the items 101 to 108 according to which an alkaline compound particle comprising sodium bicarbonate, sodium carbonate, sodium sesquicarbonate (trona), or combinations thereof, is also brought into contact with the contaminated gas.

Item 110. Process according to item 109 wherein the weight ratio of the calcium-phosphate reactant to said alkaline compound brought into contact with the contaminated gas is at least 0.001, or at least 0.005, or at least 0.010, or at least 0.020, or at least 0.030.

Item 111. Process according to any one of the items 109 or 110, wherein the weight ratio of the calcium-phosphate reactant to alkaline compound brought into contact with the contaminated gas is at most 1.00, or at most 0.50, or at most 0.40, or at most 0.30.

Item 112. Process according to any one of the items 101 to 111 wherein the calcium-phosphate reactant is brought into contact with the contaminated gas as an aqueous suspension (D), or as a wet solid (D′), or as a pulverulent solid (D″).

Item 201. Process for treating a gas stream contaminated by at least one element, said gas stream presenting peaks of concentration of the at least one element in the gas stream versus time, wherein the at least one element is selected from the group consisting of metals, organic compounds, and combinations thereof,

according to which a calcium-phosphate reactant (reagent) particle comprising apatite is brought into contact with the contaminated gas stream at a temperature of at least 30° C. and preferably at most 1100° C.,

and said process comprising:
(a) measuring the at least one element concentration in the contaminated gas stream,
(b) injecting in the contaminated gas stream an alkaline compound particle selected among the list of: sodium bicarbonate, sodium carbonate, sodium sesquicarbonate (trona), quick lime, hydrated lime, lime stone and any mixture thereof,
(c) injecting the calcium-phosphate reactant at a given flow-rate in the contaminated gas stream,
(d) removing the calcium-phosphate reactant and the at least one alkaline compound that have been in contact with the contaminated gas stream from the gas stream on a filter to obtain a treated gas stream,
(e) measuring the at least one element concentration in the treated gas stream,
(f) increasing/(or)decreasing the flow-rate of the calcium-phosphate reactant injected at step (c) when the measured concentration of the at least one element at step (a) respectively increases/(or) decreases during peaks of concentration so that to maintain on the filter at least a part of the calcium-phosphate reactant still able to adsorb the at least one element, and so that to maintain the at least one element concentration in the treated gas stream below a targeted concentration value.

Item 202. Process according to item 201 wherein at step (b) the alkaline compound particle is a dry powder, and wherein preferably at step (c) injection of the calcium-phosphate reactant is a dry powder injection or a semi-dry injection of a slurry of the calcium-phosphate reactant.

Item 203. Process according to items 201 or 202 wherein the contaminated gas stream temperature is at least 100° C., or at least 120° C., or at least 150° C.

Item 204. Process according to any one of items 201 to 203 wherein the contaminated gas stream temperature is at most 300° C.

Item 205. Process according to any one of the items 201 to 204 wherein the contaminated gas stream temperature is at most 250° C.

Item 206. Process according to any one of the items 201 to 205 wherein the contaminated gas stream temperature is at most 200° C.

Item 207. Process according to any one of the items 201 to 206 wherein at least one element selected from the group consisting of metals, organic compounds, and combinations thereof is selected among the list of: Al, Ag, As, Ba, Be, Bi, Ce, Co, Cd, Cu, Cr, Fe, Hf, Hg, La, Li, Mg, Mn, Mo, Ni, Pb, Pd, Rb, Sb, Se, Sn, Sr, Th, Ti, U, V, Y, Zn, Zr, VOC, aromatic compounds, PAHs, dioxins, furans, or any mixture thereof.

Item 208. Process according to any one of the items 201 to 207 wherein the weight ratio of the at least one element flow rate in the contaminated gas stream to the calcium-phosphate reactant flow-rate is at least 0.01, or at least 0.02, or at least 0.05 g/kg.

Item 209. Process according to any one of the items 201 to 208 wherein the weight ratio of the at least one element flow rate in the contaminated gas stream to the calcium-phosphate reactant flow-rate is at most 1.00, or at most 0.50, or at most 0.20, or at most 0.10 g/kg.

Item 210. Process according to any one of the items 201 to 209 wherein the decreasing of the flow-rate of the calcium-phosphate reactant injected at step (c) when the measured concentration of the at least one element at step (a) decreases, is delayed of a time of at least 1 minute, or at least 2 minutes, or at least 3 minutes, and preferably at most 10 minutes, or preferably at most 5 minutes during peaks of concentration.

Item 211. Process according to any one of the items 201 to 210 wherein the calcium-phosphate reactant is obtainable by the process of any items 1 to 16 of this patent application.

Item 212. Process according to any one of the items 201 to 211 wherein the calcium-phosphate reactant is a reactant according to any items 17 to 30 of this patent application.

Item 213. Process according to any one of the items 201 to 212 wherein the contaminated gas stream comprises at least one acidic gas selected among the list of: HF, HCl, HBr, HI, SO2, SO3, H3PO4, and mixtures thereof,

said process comprising the steps:
(a′) measuring the at least one acidic gas concentration in the contaminated gas stream,
(e′) measuring the at least one acidic gas concentration in the treated gas stream,
(f) increasing/(or) decreasing the flow-rate of the alkaline compound at step (b) when the measured concentration of the at least acidic gas at step (a′) respectively increases/(or) decreases so that to maintain the at least one acidic gas concentration in the treated gas stream below a targeted concentration value of said at least acidic gas.

Item 214. Process according to any one of the items 201 to 213 wherein the weight ratio of the calcium-phosphate reactant to said alkaline compound brought into contact with the contaminated gas is at least 0.001, or at least 0.005, or at least 0.010, or at least 0.020, or at least 0.030, or at least 0.045.

Item 215. Process according to any one of the items 201 to 214, wherein the weight ratio of the calcium-phosphate reactant to alkaline compound brought into contact with the contaminated gas is at most 1.00, or at most 0.50, or at most 0.40, or at most 0.30.

Item 216. Process according to any one of the items 201 to 215, wherein the weight of the calcium-phosphate reactant (reagent) comprising apatite reported to the volume of the contaminated gas-stream is at least 5, or at least 10, or at least 20, or at least 40 mg of apatite/Nm3.

Item 217. Process according to any one of the claims 201 to 216, wherein the weight of the calcium-phosphate reactant (reagent) comprising apatite reported to the volume of the contaminated gas-stream is at most 800 or at most 600 mg of apatite/Nm3, in particular for treating peaks of concentration of the at least one element.

Item 218. Process according to any one of the items 201 to 217, wherein active carbon or lignite coke is injected before or after steps (b) or (c) and before step (d), preferably at a flow rate of about 30 or about 50 and preferably at most 100 mg/Nm3.

Item 219. Process according to any one of the items 201 to 218, wherein the number of peaks of concentrations of the at least one element per 24 hours is: at least 1 peak, or at least 5 peaks.

Item 220. Process according to any one of the items 201 to 219, wherein the number of peaks of concentrations of the at least one element per 24 hours is: at most 40 peaks or at most 30 peaks or at most 20 peaks.

Item 221. Process according to any one of the items 201 to 220, wherein the at least one element is a metal and its concentration in the gas stream to be treated is: at least 0.05, or at least 0.50, or at least 5.0 mg/Nm3; and preferably its concentration in the treated gas stream is: at most 0.10, or at most 0.05, or at most 0.02 mg/Nm3.

Item 222. Process according to any one of the items 201 to 221, wherein the at least one element is a VOC and/or an aromatic such as: acroleine, acrylonitrile, benzaldehyde, actelydehyde, acetone, styrene, benzene, toluene, carbon tetrachloride, trichloromethan, methylene chloride, trichlorethylen, tetrachlorethylene, 1,1,1 trichloroethane, chlorobenzene, naphthalene, phenol, diethylphtalate selected among and its concentration in the treated gas stream is: at most 50, or at most 20, or at most 10 mg TOC (Total Organic Carbon)/Nm3.

Item 223. Process according to any one of the items 201 to 222, wherein the at least one element is a dioxin or a furan and its concentration in the contaminated gas stream is preferably at most 100, or at most 50, or at most 20 ng I-TEQ/Nm3, and preferably its concentration in the treated gas stream is preferably: at most 0.5, or at most 0.2, or at most 0.1 ng I-TEQ/Nm3.

Item 224. Process according to any one of the items 201 to 223 wherein the filter used at step (d) is a bag filter or an electrostatic precipitator (ESP), preferably a bag filter.

Item 225. Process according to any one of the items 201 to 224 wherein the calcium-phosphate reactant is brought into contact with the contaminated gas as an aqueous suspension (D), or as a wet solid (D′), or as a pulverulent solid (D″).

Item 226. Process according to any one of the items 201 to 225 comprising after step (d) or after step (e) or after step (f):
(g) mitigating the treated gas stream to reduce NOx concentrations with a selective catalytic reduction (SCR) process.

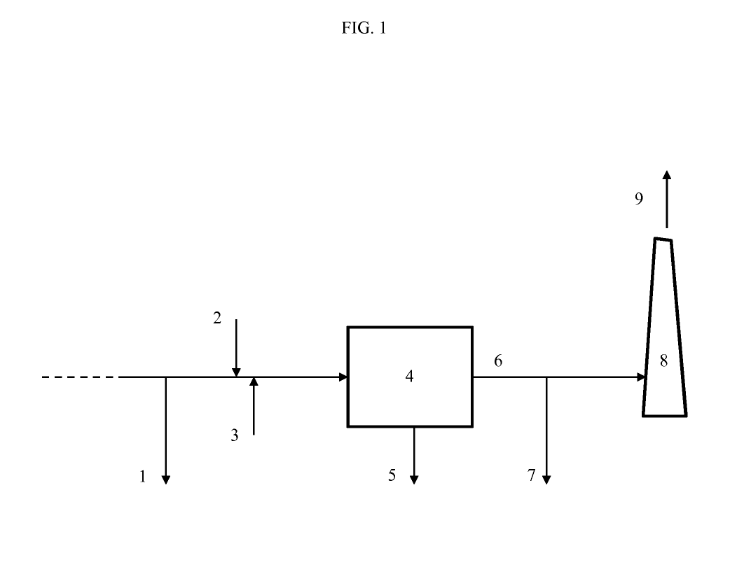

FIG. 1 is a schematic of a treatment line according to an embodiment of the present invention, wherein a flue gas stream (dashed line of the FIG. 1), contaminated in at least one element addressed by present invention, is treated by
first (step (a)): part of the gas stream is directed toward an analyzer 1 to measure the element concentration in the contaminated gas stream,
second (step (b)): an alkaline compound 2 is injected in the contaminated gas stream,
third (step (c)): a particulate reactant containing apatite 3 is injected into the contaminated gas stream
fourth (step (d)): the alkaline compound and reactant containing apatite having adsorb at least part of the contaminant element are separated from gas stream in a solid particle separator 4 to obtain a residual reactant 5 and a treated gas stream 6
fifth (step (e)): part of the gas stream is directed toward an analyzer 7 to measure the element concentration in the treated gas stream and the remaining treated gas stream 9 can be released in the atmosphere through a stack 8.

The disclosure of all patent applications, and publications cited herein are hereby incorporated by reference, to the extent that they provide exemplary, procedural or other details supplementary to those set forth herein.

Should the disclosure of any of the patents, patent applications, and publications that are incorporated herein by reference conflict with the present specification to the extent that it might render a term unclear, the present specification shall take precedence.

Each and every claim is incorporated into the specification as an embodiment of the present invention. Thus, the claims are a further description and are an addition to the preferred embodiments of the present invention.

While preferred embodiments of this invention have been shown and described, modifications thereof can be made by one skilled in the art without departing from the spirit or teaching of this invention. The embodiments described herein are exemplary only and are not limiting. Many variations and modifications of systems and methods are possible and are within the scope of the invention.

Accordingly, the scope of protection is not limited by the description and Examples set out above, but is only limited by the claims which follow, that scope including all equivalents of the subject matter of the claims.

The present invention having been generally described, the following Examples are given as particular embodiments of the invention and to demonstrate the practice and advantages thereof. It is understood that the examples are given by way of illustration and are not intended to limit the specification or the claims to follow in any manner.

### EXAMPLES

In the following examples the pH measurements were made using a WTW Sentix 41 electrode (pH 0-14, temperature: 0° C.-80° C.), a pH meter WTW pH3110. The calibration of the equipment was made using three buffer solutions: at pH 4.0 (batch Dulco test-0032) Prominent, a WTW pH 7.0 (WTW D-82362) and at pH 10.01 Hach (cat 27702). Note: If multiple sample measurements were to be made with the same electrode, the electrode was rinsed with deionized water between each measurement.

The measurement of the residual water was performed using an infrared analyser Ref. MA150C from Sartorius. For this, 10 to 20 g of product are dried at 105° C. till a constant weight is obtained during at least 5 minutes.

The particle size measurement was carried out on a Beckman Coulter LS 230 laser diffraction particle size analyser (laser of wavelength 750 nm) on particles suspended in water and using a size distribution calculation based on Fraunhofer diffraction theory (particles greater than 10 μm) and on Mie scattering theory (particles less than 10 μm), the particles being considered to be spherical.

The BET specific surface area was determined by gas adsorption on a Micromeritics ASAP2020 machine. Before the analysis, the samples (0.7 to 1 g) are pretreated under vacuum at 250° C. until a stable vacuum of 4-5 μbar has been achieved. The measurements were carried out using nitrogen as adsorbent gas at 77° K via the volumetric method, according to the ISO 9277: 2010 standard (Determination of the specific surface area of solids by gas adsorption—BET method). The BET specific surface area was calculated in a relative pressure (P/P0) range varying from around 0.05 to 0.20.

In the examples, the metal contents of the substances in the solid state were measured in the following manner. A sample of the substance to be analysed (around 200 mg) had 1 ml of 65% Suprapur nitric acid and 3 ml of 37% Suprapur hydrochloric acid added to it, then it was subjected to microwave radiation in a hermetically-sealed container in order to mineralize it (destruction of the (hydro)carbon matrix in order to obtain a mineral residue containing the analytes). This solution, with the addition of an internal standard (scandium) was made up to volume (50 ml) with ultrapure water. The solution to be analysed was then filtered if necessary (0.45 μm) and injected in the form of an aerosol into an argon plasma sustained by inductive coupling. At temperatures of 6000 to 8000° K, the atoms and ions formed from the sample were excited and returned to the ground state by emitting radiation with wavelengths characteristic of the element in the UV/visible range (130 nm to 800 nm) (ICP OES).

The various radiation wavelengths were separated by diffraction on a grating having a large number of lines and the intensity of the chosen lines was measured. The concentration of the target elements in the measurement solution was obtained after calibrating the instrument with solutions of known concentrations of each of the target elements. The concentration of these elements in the starting sample was then calculated taking into account the dilution performed during the various preparation steps.

In the examples, the metal activity test (also called metal trapping activity or metal adsorption activity) is measured according the following operating procedure. An activity test needs at least 1 litre of stock solution; for this: Prepare more than one litter stock solutions of 200 mg/l of the metal to be tested (for Cu, Ni Zn, the following soluble metal salts may be used respectively: CuSO₄.5H₂O, NiCl₂, ZnCl₂), measure the initial metal concentration with spectrophotometric kits Hach-Lange after a dilution of 50 times (ref: Cu-LCK329, Ni-LCK337, Zn-LCK360). Measure the dry matter (DM) of apatite by using an infrared analyser type MA150C by Sartorius. Introduce the apatite, equivalent 100% dry matter, (respectively 1 g DM for zinc activity, 1.5 g DM for copper activity and 5 g DM for nickel activity) in bottles of 1 liter, filled with 1 liter of the corresponding stock solution. Shake the bottles for 3 hours at 10 rpm, with a lab rotating machine (such as the ones used on TCLP test). Sample 10 ml of the solution with a syringe and filter it with a Millipore filter (0.45 μm), recover the filtrate into a test tube. Take precisely 1 ml of solution in the test tube and perform a precise dilution of 50. Residual metals concentration are analyzed with spectrophotometric kits Hach-Lange (ref: Cu-LCK329, Ni-LCK337, Zn-LCK360). After correction of dilution factors, the quantity of adsorbed metal is calculated by difference of the initial concentration and the residual one.

### Example 1

In this example a calcium phosphate (Ca/P) reactant made according the example 8 (condition according example 1.b) of WO2015/173437 patent application, comprising 5% water, and the remaining comprising mainly hydroxyapatite Ca5(PO4)3(OH), was tested in Lab and then in a Mini-pilot installation using part of an industrial gas stream from a crematorium.

### 1.a Preliminary Lab Tests

### Conditions:

generation of a contaminated gas with air
contaminants tested: Cd, Pb, Zn (introduced as chloride salt)
in oven at temperature of 600 to 700° C.
with an air flow at 150 NL/h

All the 3 contaminants (Cd2+, Pb2+ and Zn2+) were positively trapped in one pass and show excellent adsorption capacity (see table 1) when gas stream was in contact with the calcium-phosphate reactant.

TABLE 1
Adsorption capacity of apatite based calcium-phosphate reactant.
Decision to test the Ca/P reactant in industrial gas stream.

| | Adsorption Capacity |
|---|---|
| | in Lab experiment of the |
| Metal | calcium-phosphate reactant |
| Cd²⁺ | ±110 mg/g |
| Pb²⁺ | ±90 mg/g |
| Zn²⁺ | ±70 mg/g |

### 1.b Mini-Pilot Tests on Industrial Gas Stream

Part of the gas stream of Uitzicht crematorium after quench, presenting a temperature of 200° C. was derived in a fixed bed Apatite cartridge that was electrically heated at same temperature and thermally insulated. The gas line was properly heated to avoid any condensation. Temperature after Apatite cartridge (temperature after treatment) was about 150-160° C.

Same sampling point of the gas stream was used for a second experiment realized on bottles comprising apatite in watery suspension (10 g apatite for 300 ml water), and then bubbling of the treated gas in a dichromate solution to trap residual mercury (Hg). Temperatures of treated gas stream were less than 90° C. typically 25-30° C.

In both dispositions: +/−1 m3 of flue gasses were sampled.

The following analyses were performed:
Analyses of Apatite reactant (with drying at room temp if necessary)
Analyses of watery solutions
Analyses of mercury trap (Hg only)
Analyses of fly ashes on glass fibres (see picture)
Analyses of a small fraction (<0.1%) of reacted dry Apatite (=“grey Apatite”) present just behind glass fibres—no visible fly ashes
Analyses of the current reactant/fly ashes present on the baghouse filter

Results of the mini pilot tests:
No Hg in the mercury traps (both: fixed bed and watery suspension mercury traps)
No metals in the watery solutions detected (showing adsorption of metals in the Ca/P reactant)
Solid analysis: having adsorbed contaminants) see on table 2.

One can see on the results of table 2:
first and second columns the content of contaminants in virgin Ca/P reactant before treatment of the gas stream.
Analyses of the fly ashes present on the glass fibre placed before the fixed bed of Ca/P reactant is indicated on fourth column,
The analysis of fly ashes and current reactant used at Uitzicht on baghouse is indicated in third column,
Analysis of a small fraction (<0.1%) of reacted dry apatite (=“grey apatite present just behind glass fibres) is indicated in last column.
Fly ashes of glass fibre comprise small amounts (0.1-1 g/kg) of Al, Cr, Fe, Sb and very small amount of mercury Hg (0.028 g/kg).
“Grey” Apatite solid on the fixed bed show adsorption of Al, Cr, Fe, Hg, Mn, Mo, Pb, Sb, Sn, Ti, Zn.

TABLE 2
Solid analysis in contaminant before and after treatment of the gas
stream (+/−1 m3)

| | | | | Fly | |
|---|---|---|---|---|---|
| Metal | Dry Apatite | Wet Apatite | Fly Ashes and | Ashes | “grey” |
| content | (before | (before | Reagent on | glass | Apatite |
| g/kg | treatment) | treatment) | baghouse | fibre | solid |
| Ag | <0.001 | <0.001 | 0.024 | — | — |
| Al | 0.24 | 0.28 | 1.2 | 1.1 | 0.3 |
| Au | <0.002 | <0.002 | <0.002 | — | — |
| Co | <0.001 | <0.001 | 0.003 | <0.01 | <0.005 |
| Cr | 0.004 | 0.004 | 0.093 | 0.12 | 0.024 |
| Fe | 0.33 | 0.35 | 5.6 | 1.3 | 0.37 |
| Hg | <0.002 | <0.002 | 0.92 | 0.028 | 0.014 |
| Mn | 0.004 | 0.044 | 0.34 | 0.13 | 0.056 |
| Mo | 0.001 | 0.001 | 0.002 | 0.012 | 0.004 |
| Ni | 0.001 | 0.001 | 0.008 | 0.046 | <0.005 |
| Pb | 0.005 | <0.003 | 1.9 | 1.6 | 0.89 |
| Pt | <0.005 | <0.005 | <0.005 | <0.02 | <0.02 |
| Sb | <0.005 | <0.005 | 0.91 | 0.16 | 0.043 |
| Sn | <0.003 | <0.003 | 0.057 | 0.059 | 0.018 |
| Ti | 0.006 | 0.006 | 0.63 | 0.2 | 0.009 |
| Zn | 0.048 | 0.008 | 10 | 5.9 | 4.5 |

Due to:
the absence of Hg in the mercury traps
no dissolution of metals in the watery solutions
all metals were found on the current reactant, the fly ashes and the grey Apatite, we can conclude that: Apatite captures Hg and others metals present in the gas.

Some other tests were done with several metals and organics to check the ability to adsorb such contaminant elements. Part of them are described in European patent application n° EP2015/060923 and published as WO 2015/173437 (at examples 7 to 13). Also several tests were conducted with Hf and Zr confirming the ability of calcium phosphatre apatite to adsorb such elements.

It was then decided to carry out as a next step, an industrial test.

### Example 2—Industrial Test

For the industrial test at Uitzicht crematorium, it was used a concomitant injection of sodium bicarbonate and apatite according the industrial test scheme of FIG. 1

Temperature of fumes when Apatite and Sodium Bicarbonate injected were at 180° C.

Mercury and other metal were analysed before cyclone and in the stack. For the industrial test, regarding place and dispositions of gas stream sampling and metal analysis:
Same point as first trial, with glass fibre filter
and then Stack, with glass fiber filter before bubbling the gas streams sampled.

Results of the industrial tests are given on Table 3 and in the following comments:
regarding metal analysis in gas stream:
   no Hg in Hg traps (dichromate solution=Hg trap) from quench and stack,
   very low concentrations in solutions of filtered gasses,
   levels in flue gas are far below exploitation limits,
   noticeable effect only on some metals (Ag, Al, Cr, Fe, Mn, Ni, Sn, Zn) due to concentrations below detection limits (Au, Co, Hg, Mo, Pb, Pt, Sb, Ti)
regarding reacted solid analysis on bag filter with fly ashes (simple filtration):
   all metal analysed above detection limits except Au and Pt
   significant presence of Ag, Al, Co, Cr, Fe, Hg, Mn, Mo, Ni, Pb, Sb, Sn, Ti, Zn.

### Example 3—Industrial Test

Industrial tests were performed in a household waste incinerator of 11 t/h capacity. The gas stream to be treated was 63 000 Nm3/h. The treatment line, equipped with a dry mitigation injection of alkaline compounds able to inject sodium bicarbonate or hydrated lime, for mitigation of acidic gasses (HCl, HF, SO2, SO3) and equipped with an active carbon adsorbent injection for heavy metals, dioxins and furan, and aromatic organics including benzo(a)pyrene. The mean HCl concentration in gas stream was about 1100 mg/Nm3 (at 11% 02) and mean SOx concentration was about 205 mg/Nm3. Temperature of gasses at the injection points was about 230° C. Mean sodium bicarbonate injection flow rate reported per ton of waste was about 14.8 kg/t of waste and active carbon injection flow rate about 0.4 kg/t of waste. The contact time of alkaline compound and adsorbent (related to the length of fumes pipes up to downstream filtration media) was about 3 seconds. The gas stream was then filtered on a bag-house filter (960 bags of 4 meters high diameter 150 mm and total filtration surface of 1800 m², corresponding to a filtration speed toward the filtration media of 1 m/min). Temperature of gas stream before bag filter was about 210° C. Concentration of dust after the bag-filter of the treated gas stream achieved was below 5 mg/Nm3.

The incinerator treatment line was equipped with heavy metal analyser, including one Hg continuous analyser VM3000 (supplier ACW) for measuring Hg content of the contaminated gas stream (sampling point at the exit of the boiler) before alkaline reactant injection. And one Hg continuous analyser SM-4 from Mercury instruments after gas treatment (downstream the bag filter).

3.1—The injection of 2.8 kg/h of active carbon enabled to control Hg concentration in treated gas from 140 μg Hg/m3 (mean value) during tests to below 30 μg/m3 (mean value) so below the regulation limit of 0.05 mg Hg/m3 (50 μg Hg/m3) of European directive 2000/76/CE.

Though several concentrations peaks of the contaminated gas stream (after boiler and before treatment) generated 10 peaks of Hg concentration after gas treatment on 14 hours duration time (the peaks having typical duration of 4 to 10 minutes) with values above 50 μg/m3. Calculated values of active carbon needed to absorb such peaks lead to peak flow rate of more than 30 kg/h that was known by the operators to generate subsequent problems on filtration media (PTFE) due to local inflammation of active carbon.

3.2—Then basic active carbon at 2.8 kg/h flow rate was maintained with the addition of 8 kg/h of a calcium phosphate reagent in powder form, similar to the one used in example 1.b and 2, but comprising 20% water.

No Hg peak above 50 μg Hg/m3 was observed during 12 hours despite several peaks upstream on raw gas (contaminated gas) close to 500 μg Hg/m3 or higher.

Measured value of cadmium+thallium on treated gas were also below 0.05 mg/m3, Measured value of Sb+As+Pb+Cr+Co+Cu+Mn+Ni+Sn+V on treated gas were below 0.5 mg/m3 (typical values before treatment on contaminated gas being from 0.1 up to 50 mg/m3 for such elements).

3.3—Then basic active carbon flow rate was totally stopped. A flow rate of 8 kg/h of the calcium phosphate reactant was injected in the raw fumes (contaminated gas stream). This amount was sufficient to achieve values of mercury below 30 μg/m3. When concentration peaks of mercury were detected after the boiler up to 500 μg/m3 values, the flow-rate of calcium phosphate reactant was gradually increased up to 28 kg/h and decreased concomitantly with the Hg values measured upstream, down to the base flow rate of 8 kg/h for Hg values on raw gas of about 100 to 170 μg/m3. The number of peaks on treated gas was reduced to only 1 peak above 0.05 mg/m3 on 12 hours.
3.4—Same conditions continued as 3.3 test conditions, though the decrease of calcium phosphate was no more concomitant with the decrease of Hg concentration on raw gas, it was decreased in same proportion but with a time delay of 3 minutes, so that to produce an excess of unreacted phosphate reactant on bag-filter. No peak above 0.05 mg Hg/m3 was observed on treated gas in those conditions on 14 hours time duration.
3.5—In another time period the operator switched from sodium bicarbonate alkaline compound to hydrated lime powder with a mean increase of about 10% of flow rate of lime injected compared to sodium bicarbonate with comparable conditions on HCl, SOx and heavy metals concentrations upstream. The phosphate reactant injection was performed in same conditions as test 3.4. As in test 3.4 the strong reduction of peaks of mercury on stack gas (treated gas) was confirmed, with less than 1 peak measured above 50 μg/m3 in 2 days.

TABLE 3
Metals in fumes analysis, and mixture (fly ashes + reagent) analysis of
example 2.

| Metal analysis in fumes | | | | | | | |
|---|---|---|---|---|---|---|---|
| Analyses of the solutions | | | | | | | |
| | | | Upper | Analyses of the fly ashes + reagent | | | |
| | | | limit to | | Bicar & | Bicar & | |
| | Quench | Stack | respect | | Active | Active | Bicar & |
| | (before | (after | (Vlarem | | Carbon | Carbon | Apatite |
| | treatment) | treatment) | limit) | | 6th May | 7th May | 8th May |
| Ag | 0.024 | 0.01 | | Ag | 9.5 | 9.8 | 5.3 |
| (mg/Nm³) | | | | (mg/kg) | | | |
| Al | 0.023 | 0.01 | | Al | 0.9 | 0.77 | 0.58 |
| (mg/Nm³) | | | | (g/kg) | | | |
| Au | <0.006 | <0.006 | | Au | <3 | <3 | <3 |
| (mg/Nm³) | | | | (mg/kg) | | | |
| Co | <0.003 | 0.003 | 5 | Co | 3 | 2.6 | 1.4 |
| (mg/Nm³) | | | | (mg/kg) | | | |
| Cr | 0.011 | 0.001 | 5 | Cr | 0.14 | 0.12 | 0.05 |
| (mg/Nm³) | | | | (g/kg) | | | |
| Fe | 0.011 | 0.007 | | Fe | 2.4 | 2.2 | 1.5 |
| (mg/Nm³) | | | | (g/kg) | | | |
| Hg | <0.006 | <0.006 | 0.2 | Hg | 0.38 | 0.28 | 0.15 |
| (mg/Nm³) | | | | (g/kg) | | | |
| Mn | 0.001 | <0.0001 | 5 | Mn | 0.48 | 0.44 | 0.2 |
| (mg/Nm³) | | | | (g/kg) | | | |
| Mo | <0.002 | <0.002 | | Mo | 5.5 | 4.6 | 2.1 |
| (mg/Nm³) | | | | (mg/kg) | | | |
| Ni | 0.003 | <0.003 | 1 | Ni | 9.8 | 8.8 | 4.4 |
| (mg/Nm³) | | | | (mg/kg) | | | |
| Pb | <0.006 | <0.006 | 5 | Pb | 3.4 | 2.9 | 0.83 |
| (mg/Nm³) | | | | (g/kg) | | | |
| Pt | <0.013 | <0.013 | | Pt | <5 | <5 | <5 |
| (mg/Nm³) | | | | (mg/kg) | | | |
| Sb | <0.020 | <0.020 | 5 | Sb | 0.7 | 0.51 | 0.25 |
| (mg/Nm³) | | | | (g/kg) | | | |
| Sn | 0.194 | 0.079 | 5 | Sn | 0.093 | 0.074 | 0.019 |
| (mg/Nm³) | | | | (g/kg) | | | |
| Ti | <0.0001 | <0.0001 | 0.2 | Ti | 1.3 | 0.59 | 0.058 |
| (mg/Nm³) | | | | (g/kg) | | | |
| Zn | 0.006 | 0.002 | | Zn | 23 | 21 | 6.1 |
| (mg/Nm³) | | | | (g/kg) | | | |

1. A process for treating a gas stream contaminated by at least one element, said gas stream presenting peaks of concentration of the at least one element in the gas stream versus time, wherein the at least one element is selected from the group consisting of metals, organic compounds, and combinations thereof,
according to which a particulate calcium-phosphate reactant comprising apatite is brought into contact with the contaminated gas stream at a temperature of at least 30° C. and preferably at most 1100° C.,
and said process comprising:
(a) measuring the at least one element concentration in the contaminated gas stream,
(b) injecting in the contaminated gas stream an alkaline compound particle selected from the group consisting of sodium bicarbonate, sodium carbonate, trona, quick lime, hydrated lime, lime stone and any mixture thereof,
(c) injecting the calcium-phosphate reactant at a given flow-rate in the contaminated gas stream,
(d) removing the calcium-phosphate reactant and the at least one alkaline compound that have been in contact with the contaminated gas stream from the gas stream on a filter to obtain a treated gas stream,
(e) measuring the at least one element concentration in the treated gas stream,
(f) increasing or decreasing the flow-rate of the calcium-phosphate reactant injected at step (c) when the measured concentration of the at least one element at step (a) respectively increases or decreases during peaks of concentration so that to maintain on the filter at least a part of the calcium-phosphate reactant still able to adsorb the at least one element, and so that to maintain the at least one element concentration in the treated gas stream below a targeted concentration value.

2. The process according to claim 1, wherein at step (b) the alkaline compound particle is a dry powder.

3. The process according to claim 1, wherein the at least one element is selected from the group consisting of Al, Ag, As, Ba, Be, Bi, Ce, Co, Cd, Cu, Cr, Fe, Hf, Hg, La, Li, Mg, Mn, Mo, Ni, Pb, Pd, Rb, Sb, Se, Sn, Sr, Th, Ti, U, V, Y, Zn, Zr, VOC, aromatic compounds, PAHs, dioxins, furans, and any mixture thereof.

4. The process according to claim 1, wherein the at least one element has a flow rate in the contaminated gas stream with a weight ratio with respect to the calcium-phosphate reactant flow-rate of at least 0.01 g/kg.

5. The process according to claim 1, wherein the weight ratio of the at least one element has a flow rate in the contaminated gas stream with a weight ratio with respect to the calcium-phosphate reactant flow-rate of at most 1.00 g/kg.

6. The process according to claim 1, wherein the decreasing of the flow-rate of the calcium-phosphate reactant injected at step (c) when the measured concentration of the at least one element at step (a) decreases, is delayed of a time of at least 1 minute during peaks of concentration.

7. The process according to claim 1, wherein the calcium-phosphate reactant is obtained by the following process:
in a first step, use is made of a source of calcium and a source of phosphate ions in water, in a molar ratio that is adjusted so as to obtain a Ca/P molar ratio of between 0.5 and 1.6, and the source of calcium is reacted with the phosphate ions at a pH of between 2 and 8, in order to obtain a suspension (A) of calcium phosphate, and
in a second step, added to the suspension (A) are an alkaline compound comprising hydroxide ions in order to set a pH of more than 8, and an additional source of calcium in order to obtain a suspension (B) of calcium phosphate reactant having a Ca/P molar ratio of more than 1.6.

8. The process according to claim 1, wherein the contaminated gas stream comprises at least one acidic gas selected from the group consisting of: HF, HCl, HBr, HI, SO2, SO3, H3PO4, and mixtures thereof,
said process comprising the steps:
(a′) measuring the at least one acidic gas concentration in the contaminated gas stream,
(e′) measuring the at least one acidic gas concentration in the treated gas stream,
(f′) increasing or decreasing the flow-rate of the alkaline compound at step (b) when the measured concentration of the at least acidic gas at step (a′) respectively increases or decreases so that to maintain the at least one acidic gas concentration in the treated gas stream below a targeted concentration value of said at least acidic gas.

9. The process according to claim 1, wherein the weight ratio of the calcium-phosphate reactant to said alkaline compound brought into contact with the contaminated gas is at least 0.001

10. The process according to claim 1, wherein the weight ratio of the calcium-phosphate reactant to said alkaline compound brought into contact with the contaminated gas is at most 1.00

11. The process according to claim 1, wherein the weight of the calcium-phosphate reactant (reagent) comprising apatite reported to the volume of the contaminated gas-stream is at least 5 mg of apatite/Nm3.

12. The process according to claim 1, wherein the weight of the calcium-phosphate reactant (reagent) comprising apatite reported to the volume of the contaminated gas-stream is at most 800 mg of apatite/Nm3.

13. The process according to claim 1, wherein active carbon or lignite coke is injected before or after steps (b) or (c) and before step (d).

14. The process according to claim 1, wherein the number of peaks of concentrations of the at least one element per 24 hours is at least 1 peak.

15. The process according to claim 1, wherein the particulate calcium-phosphate reactant is brought into contact with the contaminated gas as an aqueous suspension (D), or as a wet solid (D′), or as a pulverulent solid (D″), wherein the aqueous suspension (D) comprises at least 18% and at most 50% of calcium phosphate reactant particles, wherein the wet solid (D′) comprises at least 50% and at most 80% of calcium phosphate reactant particles, and wherein the pulverulent solid (D″) comprises at least 80% and at most 95% of calcium phosphate reactant particles and at least 5% and at most 20% of water.

16. The process according to claim 2, wherein at step (c) injection of the calcium-phosphate reactant is a dry powder injection or a semi-dry injection of a slurry of the calcium-phosphate reactant.

17. The process according to claim 6, wherein the decreasing of the flow-rate of the calcium-phosphate reactant injected at step (c) when the measured concentration of the at least one element at step (a) decreases, is delayed of a time of at most 10 minutes during peaks of concentration.

18. The process according to claim 13, wherein active carbon or lignite coke is injected at a flow rate of at most 100 mg/Nm3.

19. The process according to claim 1, wherein the filter used at step (d) is a bag filter or an electrostatic precipitator (ESP).

20. The process according to claim 1, wherein the calcium-phosphate reactant comprises water.
